(19) United States
(12) Patent Application Publication
(10) Pub. No.: US 2005/0019669 A1
(43) Pub. Date: Jan. 27, 2005

(54) Polymer electrolyte for rechargeable lithium battery and rechargeable lithium battery comprising same

(76) Inventors: Won-Chull Han, Suwon-si (KR); Takaki Mori, Suwon-si (KR); You-Mee Kim, Suwon-si (KR)

Correspondence Address: CHRISTIE, PARKER & HALE, LLP, PO BOX 7068, PASADENA, CA, 91109-7068, US

(21) Appl. No.: 10/884,873

(22) Filed: Jul. 1, 2004

(30) Foreign Application Priority Data
Jul. 1, 2003 (KR) 2003-0044407

(51) Int. Cl. H01M 10/40

(52) U.S. Cl. 429/317; 429/189; 429/307

(57) ABSTRACT

Disclosed is a polymer electrolyte for a rechargeable lithium battery including a monomer including an alkyl acrylate having an alkyl group with a carbon number equal to or less than 4, a di-acrylate having a carbon number equal to or less than 12, or a mixture thereof; a polymerization initiator; and an electrolyte including a non-aqueous organic solvent and a lithium salt.

### CROSS-REFERENCE TO RELATED APPLICATION

This application is based on application No. 2003-44407 filed in the Korean Intellectual Property Office on Jul. 1, 2003, the entire disclosure of which is incorporated herein by reference.

### FIELD OF THE INVENTION

The present invention relates to a polymer electrolyte for a rechargeable lithium battery and a rechargeable lithium battery comprising same and, more particularly, to a polymer electrolyte for a rechargeable lithium battery which is capable of improving battery safety, and a rechargeable lithium battery comprising same.

### BACKGROUND OF THE INVENTION

Recently, the rapid development of smaller, lighter, and higher performance communication and other electronic equipment has required the development of high performance and large capacity batteries to power such equipment. The demands for large capacity batteries have fostered investigation of rechargeable lithium batteries, which are further classified as lithium ion batteries using a liquid electrolyte, and lithium polymer batteries using a polymer electrolyte.

The lithium polymer battery is expected to have improved safety over than the liquid electrolyte-type battery, because the solid polymer electrolyte has low reactivity with lithium. The polymer electrolyte is a non-aqueous organic solvent with a lithium salt immersed in a polymer matrix. Examples include those disclosed in Japanese Patent Laid-Open No. Hei. 8-507407, in which an interposed electrolyte of flexible polymer contains a lithium salt dissolved in a polymer-compatible solvent. U.S. Pat. No. 4,620,944 discloses an ionically conductive material for an electrolyte comprised of a salt in solution in a macromolecular material, the macromolecular material including at least two polyether chains connected to each other via an atomic bridge, the atomic bridge being at least one member selected from the group consisting of silicon, cadmium, boron, and titanium atoms.

However, the polymer electrolyte has insufficient strength to completely prevent short circuits between a positive electrode and a negative electrode, thereby causing reliability or safety problems. Furthermore, the ability to maintain an electrolytic solution of the polymer matrix may be changed during the repeated charge and discharge cycles, so that leakage from the polymer matrix occurs at varied voltages or with the passage of time, thereby deteriorating cycle life characteristics.

### SUMMARY OF THE INVENTION

It is an aspect of the present invention to provide a polymer electrolyte for a rechargeable lithium battery having good mechanical strength to prevent a short circuit between a positive electrode and a negative electrode.

It is another aspect to provide a polymer electrolyte for a rechargeable lithium battery exhibiting a constant good ability to maintain an electrolytic solution.

It is still another aspect to provide a polymer electrolyte for a rechargeable lithium battery including the polymer electrolyte.

These and other aspects may be achieved by a polymer electrolyte for a rechargeable lithium battery, which polymer electrolyte has as monomers an alkyl acrylate in which an alkyl group has a carbon number equal to or less than 4, a di-acrylate with a carbon number equal to or less than 12, or a mixture thereof; a polymerization initiator; and an electrolytic solution including a non-aqueous organic solvent and a lithium salt.

In order to achieve these aspects and others, the present invention further provides a rechargeable lithium battery including the polymer electrolyte; a positive electrode; and a negative electrode. The positive electrode and the negative electrode respectively include active materials in which a lithium intercalation reaction reversibly occurs.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a schematic view showing an embodiment of a structure of the lithium secondary battery of the present invention.

### DETAILED DESCRIPTION OF THE INVENTION

The present invention relates to a polymer electrolyte having sufficient mechanical strength to inhibit a short circuit between a positive electrode and a negative electrode, and having a secure and sufficient ability to maintain an electrolytic solution.

The polymer electrolyte includes at least one monomer selected from the group consisting of alkyl acrylates, di-acrylates, and mixtures thereof; a polymerization initiator; and an electrolytic solution including a non-aqueous organic solvent and a lithium salt. In the alkyl acrylate, the alkyl group preferably has a carbon number equal to or less than 4, and more preferably equal to or less than 2. The di-acrylate has a carbon number equal to or less than 12, and more preferably equal to or less than 8.

Preferred monomers are methyl acrylate (CH₂═CHCOOCH₃), hexanediol diacrylate, or a mixture thereof. The most preferred monomers are a mixture of methyl acrylate and hexanediol diacrylate at a weight ratio of 1:0.5 to 1:3. If the weight ratio of hexanediol diacrylate to methyl acrylate is less than 0.5, the polymerization does not completely occur. If the weight ratio of hexanediol diacrylate to methyl acrylate is more than 3, the compatibility to polymer decreases, so that separation between solid and liquid occurs and the obtained polymer easily becomes brittle, thereby not obtaining adherence and flexibility and causing reliability problems.

The monomers is preferably presented in an amount of 1 to 8 wt % in the polymer electrolyte, and preferably 3 to 6 wt %. An amount of less than 1 wt % makes it impossible to exhibit sufficient strength, and causes deterioration of the safety and cycle life characteristics. An amount of more than 8 wt % decreases ionic conductivity, deteriorating low-temperature characteristics, high-rate characteristics, and cycle life characteristics.

The polymerization initiator may be one that can initiate polymerization of the monomer. Examples are benzoyl peroxide, azoisobutyronitrile, and isobutyryl peroxide.

The electrolytic solution includes a lithium salt and an organic solvent. The organic solvent includes at least one cyclic carbonate, linear carbonate, ester, or ketone. If a mixture thereof is used, the mixing ratio can be suitably controlled according to the desired battery performances, as is well understood in the related art. The cyclic carbonates may be at least one selected from ethylene carbonate, propylene carbonate, and a mixture thereof. The linear carbonate may be at least one selected from dimethyl carbonate, diethyl carbonate, ethylmethyl carbonate, or methyl carbonate. The ester may be at least one selected from γ-butyrolactone, valerolactone, decanolide, or mevalolactone. A non-limiting example of a suitable ketone is polymethylvinyl ketone.

The lithium salt dissolves in the non-aqueous organic solvent and acts as a source for supplying lithium ions in the battery, and facilitates the working of the battery. In addition, the lithium salt activates transfer of lithium ions between a positive electrode and a negative electrode. The lithium salt may be at least one selected from LiPF₆, LiBF₄, LiAsF₆, LiCF₃SO₃, LiN(CF₃SO₂)₃, Li(CF₃SO₂)₂N, LiC₄F₉SO₃, LiClO₄, CF₃SO₃Li, LiN(SO₂C₂F₅)₂, LiSbF₆, LiAlO₄, LiAlCl₄, LiN(CₓF₂ₓ₊₁SO₂)(CₓF_{2y+1}SO₂) (where x and y are natural numbers), LiCl or LiI.

A rechargeable lithium battery with the inventive polymer electrolyte includes a positive electrode and a negative electrode.

The positive electrode includes a positive active material in which lithium intercalation reversibly occurs. Examples of the positive active material are lithium transition metal oxides such as LiCoO₂, LiNiO₂, LiMnO₂, LiMn₂O₄, or LiNi_{1-x-y}CoₓM_{y}O₂ (where 0≦x≦1, 0≦y≦1, 0≦x+y≦1; and M is a metal or rare earth, such as Al, Sr, Mg, or La).

The negative electrode includes a negative active material in which lithium intercalation reversibly occurs. Examples of the negative active material are crystalline or amorphous carbonaceous materials, or carbon composites.

The positive active material and the negative active material are respectively coated on current collectors to produce electrodes, and the electrodes are wound together with or laminated to a separator to produce an electrode element. The electrode element is inserted into a battery case such as a can, and an electrolyte is injected into the case to fabricate a rechargeable lithium battery. The separator may be a resin, such as polyethylene or polypropylene.

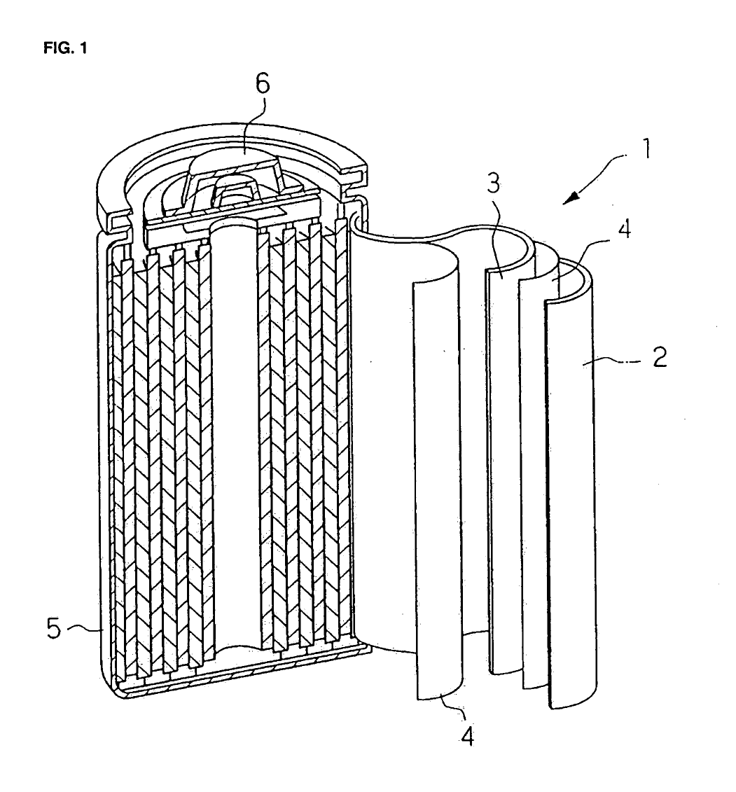

An embodiment of the rechargeable lithium battery of the present invention is shown in FIG. 1. The rechargeable lithium battery 1 includes a positive electrode 3; a negative electrode 2; a separator 4 interposed between the positive electrode 3 and the negative electrode 2; an electrolyte in which the positive electrode 2, the negative electrode 3, and the separator 4 are immersed; a cylindrical battery case 5; and a sealing portion 6. The configuration of the rechargeable lithium battery is not limited to the structure shown in FIG. 1, as it can be readily modified into a prismatic or pouch type battery as is well understood in the related art.

The following examples further illustrate the present invention in detail, but are not to be construed to limit the scope thereof.

### EXAMPLE 1

A LiCoO₂ positive active material, a graphite conductive agent, and a polyvinylidene fluoride binder were mixed in an N-methyl-2-pyrrolidone solvent at a weight ratio of 91:6:3 to prepare a positive active material slurry. The positive active material slurry was coated on an aluminum foil current collector and dried followed by compression-molding with a roller presser, thereby producing a positive electrode.

A graphite negative active material and a polyvinylidene fluoride binder were mixed in an N-methyl-2-pyrrolidone solvent at a weight ratio of 90:10 to prepare a negative active material slurry. The negative active material slurry was coated on a copper foil current collector and dried, followed by compression-molding with a roller presser, thereby producing a negative electrode.

Methyl acrylate (hereinafter, referred to as “MA”) and hexanediol diacrylate (hereinafter referred to as “HDDA”) were added to an electrolytic solution and mixed well. The weight ratio of the electrolytic solution, MA, and HDDA was 100:2:1. As the electrolytic solution, a solution of 1 M LiPF₆ in ethylene carbonate and diethyl carbonate (2:8 volume ratio) was used.

A benzoyl peroxide polymerization initiator was added to the resulting mixture at a weight ratio of 100:0.1 of the benzoyl peroxide to the resulting mixture, to prepare a composition for forming a polymer electrolyte.

Using the composition for forming a polymer electrolyte, and the positive electrode and the negative electrode, a rechargeable lithium cell was fabricated by the conventional procedure. The lithium cell was allowed to stand at a temperature of 40° C. for 15 hours to facilitate polymerization of the composition and formation of a polymer electrolyte. This produced a rechargeable lithium cell having a polymer film type electrolyte.

### EXAMPLE 2

A rechargeable lithium cell was fabricated by the same procedure as in Example 1, except that the mixing ratio of the electrolytic solution, MA, and HDDA was 100:1:2 by weight ratio.

### EXAMPLE 3

A rechargeable lithium cell was fabricated by the same procedure as in Example 1, except that the mixing ratio of the electrolytic solution, MA, and HDDA was 100:1.5:1.5 by weight ratio.

### COMPARATIVE EXAMPLE 1

A rechargeable lithium cell was fabricated by the same procedure as in Example 1, except that the electrolytic solution and polyethylene oxide-diacrylate (a polyethylene oxide chain having a molecular weight of 3000) were mixed at a weight ratio of 100:5 to prepare a composition for forming a polymer electrolyte.

### COMPARATIVE EXAMPLE 2

A rechargeable lithium cell was fabricated by the same procedure as in Example 1, except that the electrolytic solution was used as an electrolyte.

### COMPARATIVE EXAMPLE 3

A rechargeable lithium cell was fabricated by the same procedure as in Example 1, except that the electrolytic solution, and methyl methacrylate were mixed at a weight ratio of 100:5 to prepare a composition for a polymer electrolyte.

### COMPARATIVE EXAMPLE 4

A rechargeable lithium cell was fabricated by the same procedure as in Example 1, except that the electrolytic solution and polyvinylidene fluoride were mixed at a weight ratio of 100:5 to prepare a composition for a polymer electrolyte.

The standard capacity, the capacity retention after 400 cycles, and overcharging at 2 C were tested for the rechargeable lithium cells according to Examples 1 to 3 and Comparative Examples 1 to 4. The standard capacity was measured by charging at 0.5 C by 4.2V and a cut-off current of 0.02 C, and discharging at 0.5 C and a cut-off voltage of 3.0V. The capacity retention was measured by charging at 0.5 C by 4.2V and a cut-off current of 0.02 C, and discharging at 1 C and a cut-off voltage of 2.75V. The results are presented in Table 1.

TABLE 1

| | Standard | Capacity retention | |
|---|---|---|---|
| | capacity | after 400 cycles | Overcharging at 2 C |
| Comparative | 350 Wh/l | 90% | Combustion |
| Example 2 | | | |
| Example 1 | 340 Wh/l | 83% | OK |
| Example 2 | 355 Wh/l | 85% | OK |
| Example 3 | 350 Wh/l | 84% | OK |
| Comparative | 330 Wh/l | 68% | OK |
| Example 1 | | | |
| Comparative | 355 Wh/l | 65% | Combustion |
| Example 3 | | | |
| Comparative | 355 Wh/l | 86% | Combustion |
| Example 4 | | | |

As shown in Table 1, the cells according to Examples 1 to 3 exhibited high capacity retention of 83% or more after 400 cycles, and good safety characteristics at 2 C.

The rechargeable lithium batteries with the inventive polymer electrolyte did not combust or explode under severe conditions such as overcharging, and they exhibited improved capacity retention for the repeated charge and discharge cycles, i.e., good cycle life characteristics.

While the present invention has been described in detail with reference to the preferred embodiments, those skilled in the art will appreciate that various modifications and substitutions can be made thereto without departing from the spirit and scope of the present invention as set forth in the appended claims.

1. A composition for making a polymer electrolyte for a rechargeable lithium battery, comprising:
a monomer comprising an alkyl acrylate, a di-acrylate, or a mixture thereof, the alkyl acrylate having an alkyl group with a carbon number equal to or less than 4, and the di-acrylate having a carbon number equal to or less than 12;
a polymerization initiator; and
an electrolytic solution comprising a non-aqueous organic solvent and a lithium salt.

2. The composition of claim 1, wherein the alkyl acrylate has an alkyl group with a carbon number equal to or less than 2, and the di-acrylate has a carbon number equal to or less than 8.

3. The composition of claim 2, wherein the monomer is selected from the group consisting of methyl acrylate, hexanediol diacrylate, and a mixture thereof.

4. The composition of claim 3, wherein the monomer includes a mixture of methyl acrylate and hexanediol diacrylate at a weight ratio of 1:0.5 to 1:3.

5. The composition of claim 1, wherein the monomer is presented in an amount of 1 to 8 wt %.

6. The composition of claim 1, wherein the non-aqueous organic solvent is at least one selected from the group consisting of cyclic carbonates, linear carbonates, esters, ethers, and ketones.

7. The composition of claim 1, wherein the lithium salt is selected from the group consisting of LiPF₆, LiBF₄, LiAsF₆, LiCF₃SO₃, LiN(CF₃SO₂)₃, Li(CF₃SO₂)₂N, LiC₄F₉SO₃, LiClO₄, CF₃SO₃Li, LiN(SO₂C₂F₅)₂, LiSbF₆, LiAlO₄, LiAlCl₄, LiN(CₓF₂ₓ₊₁SO₂)(CₓF_{2y+1}SO₂) (where x and y are natural numbers), LiCl, and LiI.

8. A polymer electrolyte for a rechargeable lithium battery, comprising:
a polymer formed from an alkyl acrylate monomer, a di-acrylate monomer, or a mixture thereof; and
an electrolytic solution comprising a non-aqueous organic solvent and a lithium salt.

9. The polymer electrolyte of claim 8, wherein the alkyl acrylate has an alkyl group with a carbon number equal to or less than 4, and the di-acrylate has a carbon number equal to or less than 12.

10. The polymer electrolyte of claim 8, wherein the alkyl acrylate has an alkyl group with a carbon number equal to or less than 2, and the di-acrylate has a carbon number equal to or less than 8.

11. The polymer electrolyte of claim 10, wherein the monomer is selected from the group consisting of methylacrylate, hexanediol diacrylate, and a mixture thereof.

12. The polymer electrolyte of claim 10, wherein the monomer is a mixture of methyl acrylate and hexanediol diacrylate.

13. The polymer electrolyte of claim 12, wherein the mixture of methyl acrylate and hexanediol diacrylate has a weight ratio of 1:0.5 to 1:3.

14. The polymer electrolyte of claim 8, wherein the monomer is presented in an amount of 1 to 8 wt. %.

15. The polymer electrolyte of claim 8, wherein the non-aqueous organic solvent is at least one selected from the group consisting of cyclic carbonates, linear carbonates, esters, ethers, and ketones.

16. The polymer electrolyte of claim 8, wherein the lithium salt is selected from the group consisting of LiPF₆, LiBF₄, LiAsF₆, LiCF₃SO₃, LiN(CF₃SO₂)₃, Li(CF₃SO₂)₂N, LiC₄F₉SO₃, LiClO₄, CF₃SO₃Li, LiN(SO₂C₂F₅)₂, LiSbF₆, LiAlO₄, LiAlCl₄, LiN(CₓF₂ₓ₊₁SO₂)(CₓF_{2y+1}SO₂)(where x and y are natural numbers), LiCl, and LiI.

17. A rechargeable lithium battery comprising:
a polymer electrolyte formed by polymerizing an alkyl acrylate, a di-acrylate, or a mixture thereof, and an electrolytic solution comprising a non-aqueous organic solvent and a lithium salt;
a positive electrode comprising a positive active material which is capable of intercalating and deintercalating lithium; and
a negative electrode comprising a negative active material which is capable of intercalating and deintercalating lithium.

18. The rechargeable lithium battery of claim 17, wherein the alkyl acrylate has an alkyl group with a carbon number equal to or less than 2, and the di-acrylate has a carbon number equal to or less than 8.

19. The rechargeable lithium battery of claim 18, wherein the monomer is selected from the group consisting of methyl acrylate, hexanediol diacrylate, and a mixture thereof.

20. The rechargeable lithium battery of claim 19, wherein the monomer includes a mixture of methyl acrylate and hexanediol diacrylate at a weight ratio of 1:0.5 to 1:3.

21. The rechargeable lithium battery of claim 17, wherein the monomer is presented in an amount of 1 to 8 wt %.

22. The rechargeable lithium battery of claim 17, wherein the non-aqueous organic solvent is at least one selected from the group consisting of cyclic carbonates, linear carbonates, esters, ethers, and ketones.

23. The rechargeable lithium battery of claim 17, wherein the lithium salt is selected from the group consisting of LiPF₆, LiBF₄, LiAsF₆, LiCF₃SO₃, LiN(CF₃SO₂)₃, Li(CF₃SO₂)₂N, LiC₄F₉SO₃, LiClO₄, CF₃SO₃Li, LiN(SO₂C₂F₅)₂, LiSbF₆, LiAlCl₄, LiN(CₓF₂ₓ₊₁SO₂)(CₓF_{2y+1}SO₂) (where x and y are natural numbers), LiCl, and LiI.
